(19) United States
(12) Patent Application Publication
(10) Pub. No.: US 2025/0304730 A1
(43) Pub. Date: Oct. 2, 2025

(54) PLASTIC MATERIAL AND SHAPED ARTICLE OBTAINED THEREFROM

(71) Applicant: Basell Poliolefine Italia S.R.L., Milano (IT)

(72) Inventors: Yannic Kessler, Kriftel (DE); Erik Hans Licht, Mainz (DE); Carl Gunther Schirmeister, Denzlingen (DE); Rainer Köhler, Pegnitz (DE); Jürgen Rohrmann, Kelkheim (DE); Jue Lu, Houston, TX (US); Florian Pfeiffer, Kirchheim (DE)

(73) Assignee: Basell Poliolefine Italia S.R.L., Milano (IT)

(21) Appl. No.: 18/863,081

(22) PCT Filed: Apr. 19, 2023
(86) PCT No.: PCT/EP2023/060058

§ 371 Date: Nov. 5, 2024

Related U.S. Application Data
(60) Provisional application No. 63/339,097, filed on May 6, 2022.

(30) Foreign Application Priority Data
May 9, 2022 (EP) 22172214.3

(51) Int. Cl. C08F 210/16; C08K 7/00; H01Q 1/42

(52) U.S. Cl. CPC C08F 210/16; C08K 7/00; H01Q 1/42; C08F 2800/20; C08K 2201/005

(57) ABSTRACT

A shaped article made from or containing a plastic material made from or containing inorganic particles (M) made from or containing a metallic element, and a polymer composition (A), wherein the shaped article allows transmission of electromagnetic waves with minimal, if any, attenuation.

### FIELD OF THE INVENTION

In general, the present disclosure relates to the field of chemistry. More specifically, the present disclosure relates to polymer chemistry. In particular, the present disclosure relates to a plastic material and a shaped article made therefrom.

### BACKGROUND OF THE INVENTION

It is believed that future mobility will depend on self-driving or autonomous vehicles. Self-driving vehicles use sensors to perceive their environment and move safely with little or no human input. In some instances, the sensors are camera- or radar-based systems. Car manufacturers have used radar technology to assist with automated cruise control and parking. It is believed that car manufacturers will use the same technology, coupled with artificial intelligence, in driverless vehicles.

In a radar-based system, a transmitter produces electromagnetic waves in the radio or microwaves frequencies, which are transmitted by an antenna. The transmitted electromagnetic waves are reflected by radar-opaque objects and return to a receiver, thereby providing information on the object's location and speed as well as allowing the vehicle to move safely in the environment.

In some instances, the electromagnetic frequencies used in radar detection systems used for autonomous driving are in the range from 76 GHz to 81 GHz. It is believed that future systems may use lower or higher frequencies.

In some instances, radar detection systems are embedded in or shielded by exterior trims. In some instances, radar detection systems are embedded in bumpers. In some instances, radar transmission through plastic materials is hindered by transmission loss. Accordingly, the desired plastic materials are radar transparent, thereby allowing electromagnetic waves to pass through the cover with minimal, if any, attenuation.

### SUMMARY OF THE INVENTION

In a general embodiment, the present disclosure provides a shaped article made from or containing a plastic material made from or containing up to and including 7.0% by weight of inorganic particles (M) made from or containing a metallic element, and at least 93.0% by weight of a polymer composition (A), wherein the shaped article has thickness d ranging from 0.5 to 20 mm and fulfilling equation (I) when irradiated with an electromagnetic wave of frequency from 1 to 300 GHz

$$d = \frac{m {λ}_{0}}{2 \sqrt{{ε}_{r}}} \qquad ( I )$$

wherein
d is the thickness of the shaped article;
λ₀ is the vacuum wavelength corresponding to the frequency of the electromagnetic waves irradiating the shaped article;
εᵣ is the relative permittivity of the plastic material, and
m is a positive whole number equal to or greater than 1, and
wherein the amounts of (A) and (M) are based on the total weight of the plastic material, the total weight being 100%.

In some embodiments, the present disclosure provides a radar-based system made from or containing the shaped article and a device emitting, receiving, or both electromagnetic waves, wherein the shaped article at least partially covers the device. In some embodiments, the device is a radar detection system.

In some embodiments, the plastic material optimizes transmission, detection, or both of electromagnetic waves of frequency in the range from 1 to 300 GHz through a shaped article having thickness d ranging from 0.5 to 20 mm.

In some embodiments, the plastic material and the shaped article obtained therefrom allow the transmission of electromagnetic waves, including but not limited to radar frequencies, with minimal, if any, attenuation.

In some embodiments, the shaped article is a cover or a housing for an electromagnetic source, detector, or both, such as a radome. In some embodiments, the shaped article is a part of a vehicle, such as a bumper, shielding an electromagnetic emitting, receiving, or both device, such as a radar detection system.

In some embodiments, the amount of the inorganic particles (M) does not influence the mechanical properties of the plastic material.

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present disclosure, the percentages are expressed by weight, unless otherwise specified.

In the present disclosure, the total weight of a composition sums up to 100%, unless otherwise specified.

In the present disclosure, when the term “comprising” is referred to a polymer, a plastic material, a polymer composition, mixture, or blend, the term should be construed to mean “comprising or consisting essentially of”;

In the present disclosure, the term “consisting essentially of” means that, in addition to the specified components, the polymer, the polymer composition, the polymer mixture, or the polymer blend may be further made from or containing other components, provided that the characteristics of the polymer or of the composition, mixture, or blend are not materially affected by the presence of the other components. In some embodiments, the other components are catalyst residues and processing aids;

In the present disclosure, the term “copolymer” is referred to a polymer deriving from the polymerization of at least two comonomers, that is, the term “copolymer” includes bipolymers and terpolymers.

In some embodiments, the plastic material is made from or containing from 0.1 to 7.0% by weight, alternatively from 0.1 to 4.0% by weight, alternatively from 0.5 to 4.0% by weight, of inorganic particles (M) and from 93.0 to 99.9% by weight, alternatively from 96.0 to 99.9% by weight, alternatively from 96.0 to 99.5% by weight, of the polymer composition (A), wherein the amounts of (M) and (A) are based on the total weight of the plastic material, the total weight being 100%.

In some embodiments, the inorganic particles (M) are dispersed, alternatively uniformly dispersed, in the polymer composition (A). In some embodiments, the inorganic particles (M) are embedded in a matrix consisting of the polymer composition (A).

In some embodiments, the plastic material is made from or containing individual components in various combinations.

In some embodiments, the polymer composition (A) is made from or containing from up to and including 100% by weight of a polymer (a) selected from the group consisting of propylene polymers (a1), ethylene polymers (a2), polybutene-1 (a3), polystyrenes (a4), acrylic polymers (a5), acrylonitrile butadiene styrene polymers (a6), acrylonitrile styrene acrylate polymers (a7), polyamides (a8), polyesters (a9), polyurethanes (a10), and polycarbonates (a11), and mixtures thereof, wherein the amount of the polymer (a) is based on the weight of the polymer composition (A), the total weight being 100%.

In some embodiments, the polymer composition (A) consists of a polymer (a).

In some embodiments, the propylene polymer (a1) is selected from the group consisting of:
(a1.1) propylene homopolymers;
(a1.2) propylene copolymers with an olefin of formula CH₂—CHR, where R is hydrogen or a linear or branched C2-C8 alkyl;
(a1.3) elastomeric propylene copolymers with an olefin of formula CH₂═CHR, where R is hydrogen or a linear or branched C2-C8 alkyl;
(a1.4) recycled polypropylene (r-PP), being a waste plastic material derived from post-consumer waste, post-industrial waste, or both; and
(a1.5) mixtures thereof. In some embodiments, the (a1.2) propylene copolymers have up to and including 10.0% by weight, alternatively from 0.05% to 10.0% by weight, alternatively from 0.1% to 8.0% by weight, of units deriving from the olefin, based on the weight of (a1.2). In some embodiments, the (a1.3) elastomeric propylene copolymers have up to and including 85% by weight, alternatively from 5% to 85% by weight, alternatively from 20% to 70% by weight, of units deriving from the olefin, based on the weight of (a1.3).

In some embodiments, the propylene copolymer (a1) is a heterophasic propylene copolymer made from or containing:
(1) up to and including 90% by weight, alternatively from 10% to 80% by weight, alternatively from 15% to 70% by weight, of a propylene polymer selected from the group consisting of propylene homopolymers, propylene copolymers with an olefin of formula CH₂═CHR, where R is hydrogen or a linear or branched C2-C8 alkyl, having up to and including 10.0% by weight, alternatively from 0.05% to 10.0% by weight, alternatively from 0.1% to 8.0% by weight, of units deriving from the olefin, based on the weight of (1), and mixtures thereof; and
(2) at least 10% by weight, alternatively from 20% to 90% by weight, alternatively from 30% to 85% by weight, of an elastomeric propylene copolymer with an olefin of formula CH₂═CHR, where R is hydrogen or a linear or branched C2-C8 alkyl, having up to and including 85% by weight, alternatively from 20% to 85% by weight, alternatively from 25% to 75% by weight, of units deriving from the olefin, based on the weight of (2), wherein the amounts of (1) and (2) are based on the total weight of (1)+ (2).

In some embodiments, the olefin of propylene polymers (a1) is selected from the group consisting of ethylene, butene-1, hexene-1, 4-methyl-1-pentene, octene-1 and combinations thereof. In some embodiments, the olefin of propylene polymers (a1) is selected from the group consisting of ethylene and butene-1.

In some embodiments, propylene polymers (a1) are commercially available under the trade names Moplen, Hifax, Adstif, Clyrell, Softell, and Hiflex from LyondellBasell or Vistamaxx from Exxon Mobil. In some embodiments, the propylene polymer (a1) is under the trade names Vistamaxx™ 6102.

In some embodiments, the propylene polymers (a1) are obtained by polymerizing the relevant monomers, in the presence of a metallocene catalyst system or of a highly stereospecific Ziegler-Natta catalyst systems made from or containing:
(1) a solid catalyst component made from or containing a magnesium halide support on which a Ti compound, having a Ti-halogen bond, is present, and a stereoregulating internal donor;
(2) optionally, an Al-containing cocatalyst; and
(3) optionally, a further electron-donor compound (external donor).

In some embodiments, the solid catalyst component (1) is made from or containing TiCl₄ in an amount securing the presence of from 0.5 to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes, and combinations thereof.

In some embodiments, the donors are the esters of phthalic acids. In some embodiments, the esters of phthalic acids are as described in European Patent Application Nos. EP45977A2 and EP395083A2. In some embodiments, the esters of phthalic acids are selected from the group consisting of di-isobutyl phthalate, di-n-butyl phthalate, di-n-octyl phthalate, diphenyl phthalate, benzylbutyl phthalate, and combinations thereof.

In some embodiments, the esters of aliphatic acids are selected from the group consisting of esters of malonic acids, esters of glutaric acids, and esters of succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the stereoregulating internal electron donor compound are diesters derived from esterification of aliphatic or aromatic diols. In some embodiments, the diesters are as described in Patent Cooperation Treaty Publication No. WO2010/078494 and U.S. Pat. No. 7,388,061.

In some embodiments, the internal donor is selected from 1,3-diethers. In some embodiments, the 1,3-diethers are as described in European Patent No. EP361493, European Patent No. EP728769, and Patent Cooperation Treaty Publication No. WO02/100904.

In some embodiments, the internal donor is a mixture of aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal donor that remains fixed on the solid catalyst component (1) is 5 to 20% by moles, with respect to the magnesium dihalide.

In some embodiments, the solid catalyst component (1) is prepared as described in European Patent Application No. EP395083A2.

In some embodiments, the catalyst components are prepared as described in U.S. Pat. Nos. 4,399,054, 4,469,648, Patent Cooperation Treaty Publication No. WO98/44009A1, or European Patent Application No. EP395083A2.

In some embodiments, the catalyst system is made from or containing an Al-containing cocatalyst (2) selected from Al-trialkyls. In some embodiments, the Al-containing cocatalyst (2) is selected from the group consisting of Al-triethyl, Al-triisobutyl, and Al-tri-n-butyl. In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the external electron donor is selected from the group consisting of silicon compounds, ethers, esters, amines, heterocyclic compounds, and ketones. In some embodiments, the heterocyclic compound is 2,2,6,6-tetramethylpiperidine.

In some embodiments, the silicon compounds are selected from the group consisting of methylcyclohexyldimethoxysilane (C-donor), dicyclopentyldimethoxysilane (D-donor), and mixtures thereof.

In some embodiments, the polymerization process to obtain the propylene polymers (a1) is carried out in a continuous or batch process. In some embodiments, the polymerization process to obtain the propylene polymers (a1) is carried out in liquid phase or in gas phase.

In some embodiments, the liquid-phase polymerization occurs in slurry, solution, or bulk (liquid monomer). In some embodiments, the liquid-phase polymerization is carried out in various types of reactors. In some embodiments, the reactors are continuous stirred tank reactors, loop reactors, or plug-flow reactors.

In some embodiments, the gas-phase polymerization is carried out in fluidized or stirred, fixed bed reactors. In some embodiments, the gas-phase polymerization is carried out in a multizone circulating reactor as described in European Patent No. EP1012195.

In some embodiments, the heterophasic propylene polymers are obtained by melt blending the components (1) and (2). In some embodiments, the heterophasic propylene polymers are obtained by polymerizing the relevant monomers in at least two polymerization stages, wherein the second and each subsequent polymerization stage is carried out in the presence of the polymer produced and the catalyst used in the immediately preceding polymerization stage. In some embodiments, the heterophasic propylene polymers are obtained by polymerizing the relevant monomers in a multizone circulating reactor as described in Patent Cooperation Treaty Publication Nos. WO2011/144489 and WO2018/177701.

In some embodiments, the reaction temperature is in the range from 40° C. to 90° C. In some embodiments, the polymerization pressure is from 3.3 to 4.3 MPa, for a process in liquid phase, and from 0.5 to 3.0 MPa, for a process in the gas phase.

In some embodiments, the ethylene polymers (a2) are selected from the group consisting of:
(a2.1) thermoplastic ethylene polymers;
(a2.2) elastomeric ethylene copolymers with an alpha-olefin of formula CH₂═CHR¹, wherein R¹ is a linear or branched C1-C8 alkyl;
(a2.3) recycled polyethylene (r-PE), being a waste plastic material derived from post-consumer waste, post-industrial waste, or both; and
(a2.4) mixtures thereof. In some embodiments, the thermoplastic ethylene polymers, (a2.1) are selected from the group consisting of ultra-high molecular weight polyethylene (UHMWPE), high density polyethylene (HDPE), low density polyethylene (LDPE), linear low density polyethylene (LLDPE), and medium density polyethylene (MDPE). In some embodiments, the (a2.2) elastomeric ethylene copolymers have at least 20% by weight, alternatively from 20% to 50% by weight, of units deriving from the alpha-olefin, based on the weight of (a2.2).

In some embodiments, the alpha-olefin of ethylene polymers (a2) is selected from the group consisting of propylene, butene-1, hexene-1, octene-1, and combinations thereof.

In some embodiments, ethylene polymers (a2.1) are commercially available, for example under the trade names Alathon, Lucalen and Luflexen from LyondellBasell. In some embodiments, ethylene polymers (a2.1) are prepared by polymerization processes using Ziegler or Phillips catalysts, either in solution or in gas phase.

In some embodiments, ethylene polymers (a2.2) are commercially available. In some embodiments, the ethylene polymers (a2.2) are commercially available under the tradename of Engage from Dow®. In some embodiments, the ethylene polymers (a2.2) are commercially available under the tradenames Engage™ 8100 or Engage™ 8150. In some embodiments, the ethylene polymers (a2.2) are prepared by polymerization processes using metallocene-based catalyst systems.

In some embodiments, polybutene-1 (a3) is selected from the group consisting of butene-1 homopolymers, butene-1 copolymers with an olefin selected from the group consisting of ethylene and CH₂—CHR² alpha-olefins, wherein R² is methyl or a linear or branched C3-C8 alkyl, and combinations thereof.

In some embodiments, ethylene and propylene are the comonomers in butene-1 copolymers (a3). In some embodiments, the butene-1 copolymers (a3) have from 0.1% to 20% by weight of units derived from ethylene, the alpha-olefin, or both, based on the weight of the butene-1 copolymer (a3).

In some embodiments, the polybutene-1 (a3) is commercially available under the trade name Koattro from LyondellBasell. In some embodiments, the polybutene-1 (a3) is prepared by polymerization processes using Ziegler-Natta or metallocene-based catalyst systems. In some embodiments, the polybutene-1 (a3) is prepared using solution polymerization.

In some embodiments, polystyrenes (a4) are selected from the group consisting of thermoplastic homopolymers of styrene or of alpha-methylstyrene (a4.1), saturated or unsaturated styrene or alpha-methylstyrene block copolymers (a4.2), and recycled styrene block copolymers (r-SBC), being waste plastic materials derived from post-consumer waste, post-industrial waste, or both, (a4.3); and mixtures thereof. In some embodiments, saturated or unsaturated styrene or alpha-methylstyrene block copolymers (a4.2) have up to and including 30% by weight, alternatively from 10% to 30% by weight, of polystyrene based on the weight of (a4.2).

In some embodiments, the saturated or unsaturated styrene or alpha-methylstyrene block copolymer (a4.2) is selected from the group consisting of polystyrene-polybutadiene-polystyrene (SBS), polystyrene-poly(ethylene-butylene)-polystyrene (SEBS), polystyrene-poly(ethylene-propylene)-polystyrene (SEPS), polystyrene-polyisoprene-polystyrene (SIS), polystyrene-poly(isoprene-butadiene)-polystyrene (SIBS), and mixtures thereof.

In some embodiments, styrene and alpha-methylstyrene block copolymers (a4.2) are prepared by ionic polymerization of the relevant monomers and are commercially available under the tradename of Kraton™ from Kraton Polymers.

In some embodiments, acrylic polymers (a5) are selected from the group consisting of poly(methacrylate) (PMA), poly(methyl methacrylate) (PMMA), poly(ethyl methacrylate) (PEMA), poly(2-hydroxyethyl methacrylate) (poly-HEMA), and mixtures thereof.

In some embodiments, polyamides (a8) are selected from the group consisting of aliphatic polyamides, polyphthalamides, aromatic polyamides, polyamide-imide, and mixtures thereof.

In some embodiments, the aliphatic polyamides are selected from the group consisting of nylon PA6 and nylon PA66.

In some embodiments, polyamides (a8) are commercially available. In some embodiments, polyamides (a8) are produced by condensation polymerization processes.

In some embodiments, polyesters (a9) are selected from the group consisting of polyethylene terephthalate (PET), glycol-modified polyethylene terephthalate (PETG), polybutylene terephthalate (PBT), polylactic acid (PLA), polyglycolic acid (PGA), polycaprolactone (PCL), and mixtures thereof.

In some embodiments, polymer (a) is further made from or containing up to and including 5.0% by weight, alternatively from 0.01% to 5.0% by weight, of an additive, based on the total weight of the polymer (a), the total weight being 100%. In some embodiments, the additive is selected from the group consisting of nucleating agents, antistatic agents, anti-oxidants, light stabilizers, slipping agents, anti-acids, melt stabilizers, and combinations thereof.

In some embodiments, the polymer composition (A) is further made from or containing up to and including 50% by weight, alternatively from 2 to 50% by weight, of a component (b) selected from the group consisting of fillers, pigments, flame retardants, compatibilizers and combinations thereof, wherein the amounts of (a) and (b) are based on the total weight of the polymer composition (A), the total weight being 100%.

In some embodiments, the filler is selected from the group consisting of mineral fillers, mica, glass fibers, glass beads, carbon fibers, carbon black, natural fibers, carbon nanotubes, fullerenes, and combinations thereof. In some embodiments, the mineral fillers are talc.

In some embodiments, the pigments and flame retardants are used in the field of polyolefins.

In some embodiments, the compatibilizer is a modified olefin polymer, functionalized with polar compounds. In some embodiments, the olefin polymer is selected from the group consisting of polypropylene and polyethylene. In some embodiments, the modified olefin polymers are selected from the group consisting of graft copolymers, block copolymers, and mixtures thereof. In some embodiments, the compatibilizer is a polyolefin, alternatively selected from the group consisting of polyethylenes, polypropylenes, and mixtures thereof, functionalized with a compound selected from the group consisting of maleic anhydride, C1-C10 linear or branched dialkyl maleates, C1-C10 linear or branched dialkyl fumarates, itaconic anhydride, C1-C10 linear or branched itaconic acid, dialkyl esters, maleic acid, fumaric acid, itaconic acid, and mixtures thereof. In some embodiments, the compatibilizer is a polyethylene, a polypropylene, or both, grafted with maleic anhydride (MAH-g-PE, MAH-g-PP, or both).

In some embodiments, the modified polyolefins for use as a compatibilizer are commercially available under the tradenames Amplify™ TY from The Dow Chemical Company, Exxelor™ from ExxonMobil Chemical Company, Scona® TPPP from Byk (Altana Group), Bondyram® from Polyram Group, or Polybond® from Chemtura, and combinations thereof. In some embodiments, the modified polymers are produced by functionalization processes carried out in solution, in the solid state, or in the molten state. In some embodiments, the modified polymers are functionalized by reactive extrusion of the polymer in the presence of the grafting compound and of a free radical initiator. In some embodiments, functionalization of polypropylene, polyethylene, or both with maleic anhydride is as described in European Patent Application No. EP0572028A1.

In some embodiments, the polymer composition (A) is made from or containing:
up to and including 100% by weight, alternatively from 50% to 98% by weight, of the polymer (a), and
up to and including 50% by weight, alternatively from 2% to 50% by weight, of a component (b) selected from the group consisting of fillers, pigments, flame retardants and combinations thereof,
wherein the amounts of (a) and (b) are based on the total weight of the polymer composition (A), the total weight being 100%.

In some embodiments, the inorganic particles (M) are made from or containing a metallic element selected from the group consisting of magnesium, calcium, strontium, barium, aluminum, titanium, vanadium, chromium, iron, copper, zinc, ruthenium, rhodium, palladium, silver, tin, platinum, gold, titanium, zirconium, alloys of the metals and combinations thereof. In some embodiments, the metallic element is aluminum.

In some embodiments, the inorganic particles (M) are selected from the group consisting of metal particles, particles of inorganic compounds, and mixtures thereof.

In some embodiments, metal particles are selected from the group consisting of magnesium, calcium, strontium, barium, aluminum, titanium, vanadium, chromium, iron, copper, zinc, ruthenium, rhodium, palladium, silver, tin, platinum, gold, titanium, zirconium, alloys of the metals and combinations thereof. In some embodiments, metal particles are in the form of metal flakes. In some embodiments, metal particles are aluminum flakes.

In some embodiments, inorganic compounds are selected from the group consisting of metal oxides and mixed metal oxides, titanate and zirconates of the metals, ceramic particles made from or containing the metals, zeolites, and combinations thereof. In some embodiments, the metal oxides are Al₂O₃ or TiO₂. In some embodiments, the metal titanate is BaTiO₃. In some embodiments, the metal zirconate is Ca₂ZrO₄.

In some embodiments, the inorganic particles (M) have an average particle size D50 equal to or lower than 200 microns, alternatively equal to or lower than 150 microns, alternatively equal to or lower than 100 microns. In some embodiments, the lower limit for the average particle size is 1 micron for the upper limits above. In some embodiments, particle size is measured by laser diffraction.

In some embodiments, the inorganic particles (M) have particle size equal to or greater than 0.2 microns.

In some embodiments, the plastic material is obtained by dry blending the polymer composition (A) and the inorganic particles (M). In some embodiments, the plastic material is obtained by melt blending the polymer composition (A) and the inorganic particles (M) in melt blending equipment, by feeding the polymer composition (A) and the inorganic particles (M) sequentially or simultaneously to the equipment. In some embodiments, the melt blending equipment is a twin-screw extruder.

In some embodiments, the polyolefin composition (A) is made from or containing a polymer (a) and further component (b). In some embodiments, the polymer (a) and the further component (b) are dry blended prior to melt blending of the polyolefin composition (A) with the inorganic particles (M), thereby obtaining the plastic material. In some embodiments, the polymer (a) and the further component (b) are mixed in a melt blending equipment prior to the melt blending of the polyolefin composition (A) with the inorganic particles (M), thereby obtaining the plastic material. In some embodiments, the polymer (a), the further component (b), and the inorganic particles (M) are dry blended, thereby obtaining the plastic material. In some embodiments, the polymer (a), the further component (b), and the inorganic particles (M) are fed separately to the melt blending equipment, thereby obtaining the plastic material.

In some embodiments, the presence of the inorganic particles (M) into the plastic material in amount of up to and including 7% by weight has a limited influence on the mechanical properties of the polymer composition (A). In some embodiments, the mechanical properties of the plastic material, having up to and including 7% by weight of inorganic particles (M), do not differ from the mechanical properties of the polymer composition (A), free of inorganic particles (M).

In some embodiments, the present disclosure provides a shaped article made from or containing the plastic material. In some embodiments, the present disclosure provides a structural part of a shaped article made from or containing the plastic material.

In some embodiments, the shaped article is prepared by injection molding.

In some embodiments, the shaped article has thickness d fulfilling the following equation (I) when the shaped article is irradiated with an electromagnetic wave of frequency from 1 to 300 GHz, alternatively from 70 to 130 GHz, alternatively from 76 to 81 GHz:

$$d = \frac{m {λ}_{0}}{2 \sqrt{{ε}_{r}}} \qquad ( I )$$

wherein
   d is the thickness of the shaped article, measured at the point of the incident electromagnetic wave;
   λ₀ is the vacuum wavelength corresponding to the frequency of the electromagnetic waves irradiating the shaped article;
   εᵣ is the relative permittivity of the plastic material, and
   m is a positive whole number equal to or greater than 1.

In some embodiments, the thickness d of the shaped article ranges from 0.5 to 20 mm, alternatively from 0.5 to 15 mm, alternatively from 1 to 10 mm.

In some embodiments, 2 is a numeric value determined by the radiation with which the shaped article is irradiated.

In some embodiments, m is a whole number ranging from 1 to 20, alternatively from 1 to 16, alternatively from 1 to 10, alternatively from 1 to 6.

In some embodiments, the shaped article allows transmission of electromagnetic waves, including but not limited to radar frequencies, with minimal, if any, attenuation.

In some embodiments, the shaped article is a vehicle bumper, a cover or a housing for a device emitting, receiving, or both of electromagnetic waves, such as a radome.

In some embodiments, the shaped article at least partially, alternatively completely, covers a device emitting, receiving, or both electromagnetic waves, such as a radar detection system of an autonomous driving vehicle.

In some embodiments, the present disclosure provides a device configured to emit, receive, or both electromagnetic waves at least partially, alternatively completely, covered by the shaped article. In some embodiments, the device is a radar detection system of an autonomous driving vehicle.

In some embodiments, the present disclosure provides a plastic material made from or containing up to and including 7% by weight, alternatively from 0.05 to 7.0% by weight, of inorganic particles (M) made from or containing a metallic element, and at least 93.0% by weight, alternatively from 93.0 to 99.95% by weight, of a polymer composition (A), wherein the amounts of (A) and (M) are based on the weight the plastic material, the total weight being 100%, wherein the plastic material optimizes the transmission of electromagnetic waves of frequency in the range from 1 to 300 GHz through a shaped article having thickness d ranging from 0.5 to 20 mm.

In some embodiments, the present disclosure provides a process for shaping the plastic material into an article having thickness d fulfilling the equation (I), wherein the values of d, λ₀, εᵣ and m are as defined above. In some embodiments, the shaping is achieved by injection molding the plastic material

In some embodiments, the present disclosure provides a method for optimizing the transmission of electromagnetic waves of frequency in the range from 1 to 300 GHz though a shaped article, including the steps of:
providing a plastic material made from or containing up to and including 7% by weight, alternatively from 0.05 to 7.0% by weight, of inorganic particles (M) made from or containing a metallic element, and at least 93.0% by weight, alternatively from 93.0 to 99.95% by weight, of a polymer composition (A), wherein the amounts of (A) and (M) are based on the weight the plastic material, the total weight being 100%; and
shaping the plastic material into an article with a thickness d ranging from 0.5 to 20 mm and fulfilling the following equation

$$d = \frac{m {λ}_{0}}{2 \sqrt{{ε}_{r}}} \qquad ( I )$$

wherein
d is the thickness of the shaped article;
λ₀ is the vacuum wavelength corresponding to the frequency of the electromagnetic waves irradiating the shaped article, wherein the frequency ranging from 1 to 300 GHz;
εᵣ is the relative permittivity of the plastic material, and
m is a positive whole number equal to or greater than 1.

In some embodiments, the features are not inextricably linked to each other. In some embodiments, ranges of a feature are combined with ranges of a different feature, independently.

### EXAMPLES

The following examples are illustrative and not intended to limit the scope of the disclosure in any manner whatsoever.

### Characterization Methods

The following methods are used to determine the properties indicated in the description, claims and examples.

Melt Flow Rate: Determined according to the method ISO 1133 (230° C., 2.16 Kg for the thermoplastic polyolefins; 190° C./2.16 Kg for the compatibilizer).

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C., without stirring during the first 20 minutes, and maintained at 25° C., with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(I) and XS_{A} values were experimentally determined. The fraction of component (B) soluble in xylene at 25° C. (XS_{B}) was calculated from the formula:

$$XS = W ( A ) \times ( {XS}_{A} ) + W ( B ) \times ( {XS}_{B} )$$

wherein W(A) and W(B) are the relative amounts of components (A) and (B), respectively, and W(A)+W(B)=1.

C2 content in propylene-ethylene copolymer (II): ¹³C NMR spectra were acquired on a Bruker AV-600 spectrometer equipped with cryoprobe, operating at 160.91 MHz in the Fourier transform mode at 120° C. The peak of the P_{ββ} carbon (nomenclature according to C. J. Carman, R. A. Harrington and C. E. Wilkes, Macromolecules, 10, 3, 536 (1977)) was used as internal standard at 2.8 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H-¹³C coupling. 512 transients were stored in 32K data points using a spectral window of 9000 Hz. The assignments of the spectra, the evaluation of triad distribution and the composition were made according to Kakugo [M. Kakugo, Y. Naito, K. Mizunuma and T. Miyatake, Macromolecules, 16, 4, 1160 (1982)]. In view of the amount of propylene inserted as regioirregular units, ethylene content was calculated according to Kakugo [M. Kakugo, Y. Naito, K. Mizunuma and T. Miyatake, Macromolecules, 16, 4, 1160 (1982)] using triad sequences with P inserted as regular unit.

$$\begin{matrix}PPP = 100 {T}_{ββ} / S \\ PPE = 100 {T}_{βδ} / S \\ EPE = 100 {T}_{δδ} / S \\ PEP = 100 {S}_{ββ} / S \\ PEE = 100 {S}_{βδ} / S \\ EEE = 100 ( 0.25 {S}_{γδ} + 0.5 {S}_{δδ} ) / S \\ where S = {T}_{ββ} + {T}_{βδ} + {T}_{δδ} + {S}_{ββ} + {S}_{βδ} + 0.25 {S}_{γδ} + 0.5 {S}_{δδ}\end{matrix}$$

The molar content of ethylene and propylene was calculated from triads, using the following equations:

$$\begin{matrix}[ E ] mol = EEE + PEE + PEP \\ [ P ] mol = PPP + PPE + EPE\end{matrix}$$

The weight percentage of ethylene content (E % wt) was calculated, using the following equation:

$$E \% wt = \frac{[ E ] mol \times MWE}{( [ E ] mol \times MWE ) + ( [ P ] mol \times MWP )} \times 100$$

wherein
[P] mol=the molar percentage of propylene content;
MWE=molecular weights of ethylene
MWP=molecular weight of propylene.

The total ethylene content C2(tot) and the ethylene content of component (A), C2(A), were measured. The ethylene content of component (B), C2(B), was calculated using the formula:

$$C 2 ( tot ) = W ( A ) \times C 2 ( A ) + W ( B ) \times C 2 ( B )$$

wherein W(A) and W(B) are the relative amounts of components (A) and (B) (W(A)+W(B)=1).

Flexural Modulus: determined according to ISO 178/A: 2019-04 on injection molded specimens Type 1 according to ISO 20753.

Relative permittivity &r and attenuation: The relative permittivity was measured with a Radome Measurement System RMS-D-77/79G from perisens GmbH, performing a free space transmission (S21) measurement in amplitude and phase, which was used to determine the relative permittivity of materials in the frequency range between 76 and 81 GHz. The equipment sent radar waves with a given frequency band through the material sample. The damp of the signal was calculated with a first measurement without a sample followed by a second measurement with the sample. To calculate the permittivity, the damp between both measurements and the thickness of the sample (measured with an Mitutoyo digital sheet metal micrometer IP65) were used.

Particle size and particle size distribution: measured by laser diffraction, for example, using a Mastersizer Hydro 3000 (15 sec. testing, stirring speed 3500 rpm).

### Raw Materials:

HECO: a heterophasic polyolefin composition made from or containing 60 wt. % of propylene homopolymers (1) and 40 wt. % of a propylene-ethylene copolymer (1) having 68 wt. % of ethylene, based on the weight of the copolymer (b), wherein the amounts of (a) and (b) are based on the total weight of the HECO. The HECO was a reactor-blend of components (a) and (b) obtained as described in examples 1-2 of the Patent Cooperation Treaty Publication No. WO2005/014715A1.

Talc: Jetfine® 3 C A commercially available from Imerys Performance Additives.

Inorganic particles (M); Pellex A32-30LW commercially available from Metaflake Ltd., a pellet containing 30% by weight of polyethylene wax and 70% by weight of aluminum flakes having average particle size D50 of 32 microns.

### Comparative Examples CE1-CE2 and Example E3

A plastic material having the composition of Table 1 was prepared by compounding in a two screw extruder operated at 300 rpm, with a mass flow of 40 kg/h at 220° C. (zone 1=200° C., zone 2=210° C., zone3=220° C., zone 3=zone 4=zone 5=zone 6). The article was obtained by shaping the plastic materials having the composition of Table 1 into 2.42 mm-thick plaques using an injection molding machine with a clamping force of 1600 kN and a screw diameter of 50 mm. The extruder was operated under the following conditions:
melt temperature: 225° C.;
mold temperature: 30° C.;
average injection velocity: 100 mm/s;
cavity pressure change-over point: 150 bar;
holding pressure (hydraulic): 50 bar;
holding pressure time: 30 s;
Cooling time: 28 s.

The test specimens were irradiated with a radar frequency of 77 GHz (corresponding to a λ₀ vacuum wavelength of 3.89 mm). The equation (I) was satisfied for m=2. The value of the relative permittivity er was experimentally determined.

The compositions of the plastic materials and the tested properties of the shaped articles are reported in Table 1.

TABLE 1

| | | CE1 | CE2 | E3 |
|---|---|---|---|---|
| HECO | wt. % | 100 | 89.5 | 88.7 |
| Talc | wt. % | — | 10.5 | 9.9 |
| Inorganic particles (M) | wt. % | — | — | 1.4 |
| MFR (230° C./2.16 Kg) | g/10 min. | 12 | 10.3 | 11 |
| Flexural Modulus | MPa | 1100 | 1534 | 1569 |
| relative permittivity εr | | 2.2 | 2.36 | 2.6 |
| Attenuation | dB | 0.13 | 0.06 | 0.02 |

1. A shaped article comprising:
a plastic material comprising
up to and including 7% by weight of inorganic particles (M) comprising a metallic element, and
at least 93.0% by weight of a polymer composition (A),
wherein the shaped article has thickness d ranging from 0.5 to 20 mm and fulfilling equation (I) when irradiated with an electromagnetic wave of frequency from 1 to 300 GHz
$$d = \frac{m {λ}_{0}}{2 \sqrt{{ε}_{r}}} \qquad ( I )$$
wherein
d is the thickness of the shaped article;
λ₀ is the vacuum wavelength corresponding to the frequency of the electromagnetic waves irradiating the shaped article;
εᵣ is the relative permittivity of the plastic material; and
m is a positive whole number equal to or greater than 1, and
wherein the amounts of (A) and (M) are based on the total weight of the plastic material, the total weight being 100%.

2. The shaped article according to claim 1, wherein the plastic material comprises
from 0.1 to 7.0% by weight of inorganic particles (M) and
from 93.0 to 99.9% by weight of the polymer composition (A),
wherein the amounts of (A) and (M) are based on the total weight of the plastic material, the total weight being 100%.

3. The shaped article according to claim 1, wherein the polymer composition (A) comprises up to and including 100% by weight of a polymer (a) selected from the group consisting of propylene polymers, ethylene polymers, polybutene-1, polystyrenes, acrylic polymers, acrylonitrile butadiene styrene polymers, acrylonitrile styrene acrylate polymers, polyamides, polyesters, polyurethanes, polycarbonates, and mixtures thereof,
wherein the amount of the polymer (a) is based on the weight of the polymer composition (A), the total weight being 100%.

4. The shaped article according to claim 3, wherein the polymer (a) is a heterophasic propylene polymer comprising:
(1) up to and including 90% by weight of a propylene polymer selected from the group consisting of:
propylene homopolymers,
propylene copolymers with an olefin of formula CH₂—CHR, where R is hydrogen or a linear or branched C2-C8 alkyl, having up to and including 10.0% by weight of units deriving from the olefin, based on the weight of (1), and
mixtures thereof; and
(2) at least 10% by weight of an elastomeric propylene copolymer with an olefin of formula CH₂═CHR, where R is hydrogen or a linear or branched C2-C8 alkyl, having up to and including 85% by weight of units deriving from the olefin, based on the weight of (2),
wherein the amounts of (1) and (2) are based on the total weight of (1)+ (2).

5. The shaped article according to claim 1, wherein the polymer composition (A) further comprises up to and including 50% by weight of a component (b) selected from the group consisting of fillers, pigments, flame retardants, compatibilizers and combinations thereof,
wherein the amount of component (b) is based on the total weight of the polymer composition (A), the total weight being 100%.

6. The shaped article according to claim 1, wherein the metallic element selected from the group consisting of magnesium, calcium, strontium, barium, aluminum, titanium, vanadium, chromium, iron, copper, zinc, ruthenium, rhodium, palladium, silver, tin, platinum, gold, titanium, zirconium, alloys of the metals, and combinations thereof.

7. The shaped article according to claim 1, wherein the inorganic particles (M) are metal flakes, preferably aluminum flakes.

8. The shaped article according to claim 1, wherein the inorganic particles (M) have an average particle size D50 equal to or lower than 200 microns measured by laser diffraction.

9. The shaped article according to claim 1, wherein equation (I) is fulfilled when the shaped article is irradiated with an electromagnetic wave of frequency in the range from 70 to 130 GHz.

10. The shaped article according to claim 1, wherein m ranges from 1 to 20.

11. The shaped article according to claim 1, wherein the thickness d of the shaped article ranges from 0.5 to 20 mm.

12. The shaped article according to claim 1, wherein the shaped article is a vehicle bumper, a cover or a housing for a device emitting, receiving, or both of electromagnetic waves.

13. A radar-based system comprising:
the shaped article according to claim 1 and
a device emitting, receiving, or both electromagnetic waves,
wherein the shaped article at least partially covers the device.

14. (canceled)

15. A method for optimizing the transmission of electromagnetic waves of frequency in the range from 1 to 300 GHz though a shaped article, comprising the steps of:
providing a plastic material according to claim 1; and
shaping the plastic material into an article with a thickness d ranging from 0.5 to 20 mm and fulfilling the equation
$$d = \frac{m {λ}_{0}}{2 \sqrt{{ε}_{r}}} \qquad ( I )$$
wherein
d is the thickness of the shaped article;
λ₀ is the vacuum wavelength corresponding to the frequency of the electromagnetic waves irradiating the shaped article, wherein the frequency ranging from 1 to 300 GHz;
εᵣ is the relative permittivity of the plastic material, and
m is a positive whole number equal to or greater than 1.

16. (canceled)

17. (canceled)
